(19) United States
(12) Patent Application Publication
(10) Pub. No.: US 2002/0167115 A1
(43) Pub. Date: Nov. 14, 2002

(54) Injection molding method and injection mold assembly

(76) Inventor: Yoji Tanaka, Shiojiri-shi (JP)

Correspondence Address: William C. Rowland, BURNS, DOANE, SWECKER & MATHIS, L.L.P., P.O. Box 1404, Alexandria, VA, 22313-1404, US

(21) Appl. No.: 10/050,603

(22) Filed: Jan. 18, 2002

(30) Foreign Application Priority Data
Feb. 23, 2000 (JP) 2000-45441
Aug. 22, 2001 (JP) 2001-251084

(51) Int. Cl. B29C 45/56

(52) U.S. Cl. 264/328.1; 425/556; 425/444; 425/577

(57) ABSTRACT

Molten resin is injected into a cavity 12 formed between a cavity mold 7 and a moving-side core mold 11 in an injection mold assembly 1 and is allowed to spread out into every corner. Next, after the resin has stopped flowing, punch pins 23 and 24 are pressed into the cavity by hydraulic cylinders 25 and 26 that are attached to the fixed-side mold part 2 side. After the molten resin has hardened, the punch pins 23 and 24 are withdrawn from the cavity, the mold assembly is opened and the molded product is removed. By using the punch pins 23 and 24, through-hole parts are formed in a plate-like product. When the molten resin is injected, inside the cavity there are no through-hole-forming protrusions that would cause the flow of the molten resin to branch, so that weld lines do not appear in the surface of the molded product. As a result, plate-like molded products that include through-holes can be accurately formed by injection molding.

### BACKGROUND OF THE INVENTION

1. Field of the Invention

The present invention relates to an injection molding method and an injection mold assembly that are suited to forming a plate-like injection-molded product that has a depression, opening, or the like, and an injection-molded gear wheel with a center hole, in a manner where weld lines or weld marks are not produced.

2. Related Art Description

Plate-like injection-molded products that are made of plastic include products, such as gears and pulleys, that are formed with a central shaft hole. Such injection-molded products are formed by introducing molten resin into a cavity via a single gate or multiple gates. As one example, when a single gate is used, as shown in FIG. 12(a) an end-surface position of a molded product 90 is set as the gate position 91, and the molten resin introduced via this gate position flows in opposite directions before joining up at a position on the opposite side. As a result, a weld line 92 is produced at the part where the resin joins up.

In the case where multiple gates, such as three gates, are used, as shown in FIG. 12(b) molten resin is introduced into the cavity via gates 94, 95, and 96 that are arranged at 120° intervals at an end-surface position of a molded product 93. In this case also, three weld lines 97, 98, and 99 are formed at the three parts in the circumferential direction where the molten resin joins up.

Depending on the characteristics of the resin, risen parts or depressions are formed at the parts of the molded product where such weld lines are formed, so that there is a risk that the precision of the molded product will fall. Putting this another way, to obtain a high-precision injection-molded product, it is necessary to perform injection molding without producing weld lines.

The same problem occurs for plate-like injection-molded products that are formed with depressions or openings in some parts. As one example, for the injection-molded product 60 shown in FIG. 4(a), three (large, medium, and small) through-holes or concave parts 63, 64, and 65 are formed in a plate-like main body 62 that has a fixed thickness. Weld lines or weld marks 67a, 68a, and 69a are produced in this injection-molded product 60, which spoil the appearance and lower the manufacturing precision.

In more detail, if molten resin flows into the injection molding cavity for the injection-molded product 60 from a single gate that is positioned approximately centrally, for example, core parts for forming the three through-holes project into the cavity, so that the molten resin ends up flowing along flow paths that go around these core parts.

In FIG. 4(b), the flow paths of the molten resin in the cavity are shown by arrows. The molten resin that is injected into the cavity in this way from the single gate 66 splits and flows along a plurality of flow paths, with the split-up flow paths joining up at the end parts 67, 68, and 69 in the cavity. At such parts where the molten resin joins up, weld lines or weld marks 67a, 68a, and 69a are produced in the form of raised lines.

### SUMMARY OF THE INVENTION

It is an object of the present invention to provide an injection molding method and an injection mold assembly that are suited to injection molding an injection-molded gear wheel, pulley, or a plate-like molded product in which depressions, openings, etc., are formed without producing the weld lines or weld marks described above.

The stated object can be achieved by an injection molding method for injection molding a plate-like product that is provided with a through-hole, a depression, and the like, including steps of:

forming a cavity, which corresponds to a shape of the product without the through-hole or the depression, as a compartment between a fixed-side mold plate and a moving-side mold plate;

injecting molten resin into the cavity;

forming a part corresponding to the through-hole or the depression by having a punch pin project into the cavity from one of a fixed-side mold plate side and a moving-side mold plate side after the molten resin has spread out into every corner of the cavity and has stopped flowing; and

withdrawing the punch pin from the cavity after the molten resin that fills the cavity has hardened.

An injection mold assembly that is used for forming a plate-like product including a through-hole or the like according to the method of the present invention, includes:

a fixed-side mold part;

a moving-side mold part;

a cavity that is formed as a compartment between the fixed-side mold part and the moving-side mold part when the injection mold assembly is in a closed state;

a punch pin that can be moved to a projecting position where the punch pin projects into the cavity and a withdrawal position where the punch pin is withdrawn from the cavity; and

a pin moving mechanism for moving the punch pin to the projecting position and the withdrawal position.

Here, a fluid pressure cylinder may be used as the driving mechanism of the pin moving mechanism.

Also, the pin moving mechanism is usually attached to the fixed-side mold part side.

With the injection mold assembly and the injection molding method of the present invention, molten resin is injected into a cavity with the cavity in a state where there are no protrusions or the like that cause the flow of the injected molten resin to branch. After the cavity has been filled with molten resin, punch pins are used to form depressions, through-holes, etc. Accordingly, a plate-like product that includes depressions, through-holes, etc can be precisely formed with no weld lines or weld marks being produced.

Furthermore, the pin moving mechanism may have a construction that has only the punch pin project into the cavity when the injection mold assembly is in the closed state and has only an eject pin for ejecting a molded product from the moving-side mold plate project into the cavity when the injection mold assembly is in the opened state.

The pin moving mechanism for performing this operation may have a construction including:

a first moving plate to which the punch pin is attached;

a second moving plate to which the eject pin is attached;

a third moving plate to which a hollow knock pin for moving the first moving plate and a knock pin for moving the second moving plate are attached; and

a cylindrical guide bushing that is attached to the first moving plate and guides a front end part of the hollow knock pin.

In this case, the hollow knock pin has a construction including an engaging hook part at a front end part of the hollow knock pin, the engaging hook part being capable of switching between a state where the engaging hook part is elastically displaced in a radial direction relative to the guide bushing and engages the guide bushing and a state where the engaging hook part is released from the guide bushing.

Furthermore, a fixed-side attaching plate to which the fixed-side mold plate is attached has a construction that is equipped with a fixed-side guide pin. Also, when the injection mold assembly is in the closed state, the fixed-side guide pin is in a state where a front end part of the fixed-side guide pin has been inserted in the hollow knock pin so that the engaging hook part of the hollow knock pin does not elastically deform, while when the injection mold assembly is in the opened state, the fixed-side guide pin is in a state where the front end part of the fixed-side guide pin has been withdrawn from the hollow knock pin.

An injection mold assembly according to the present invention includes:

a fixed-side mold plate;

a moving-side mold plate;

a punch pin that is capable of projecting into a cavity formed between the fixed-side mold plate and the moving-side mold plate when the injection mold assembly is in a closed state;

an eject pin for ejecting a molded product from the moving-side mold plate when the injection mold assembly is in an opened state; and

a pin moving mechanism for having only the punch pin project into the cavity when the injection mold assembly is in the closed state and having only the eject pin project into the cavity when the injection mold assembly is in the opened state.

Here the pin moving mechanism may have a construction including:

a first moving plate to which the punch pin is attached;

a second moving plate to which the eject pin is attached;

a third moving plate to which a hollow knock pin for moving the first moving plate and a knock pin for moving the second moving plate are attached; and

a cylindrical guide bushing that is attached to the first moving plate and guides an end of the hollow knock pin.

In this case, the hollow knock pin has a construction including an engaging hook part at a front end part of the hollow knock pin, the engaging hook part being capable of switching between a state where the engaging hook part is elastically displaced in a radial direction relative to the guide bushing and engages the guide bushing and a state where the engaging hook part is released from the guide bushing. Furthermore, a fixed-side attaching plate to which the fixed-side mold plate is attached has a construction that is equipped with a fixed-side guide pin. Also, when the injection mold assembly is in the closed state, the fixed-side guide pin is in a state where a front end part of the fixed-side guide pin has been inserted in the hollow knock pin so that the engaging hook part of the hollow knock pin does not elastically deform, while when the injection mold assembly is in the opened state, the fixed-side guide pin is in a state where the front end part of the fixed-side guide pin has been withdrawn from the hollow knock pin.

When the injection mold assembly of the present invention is used to injection mold a gear wheel or a pulley with a shaft hole formed in the center, a gate of the cavity may be a disc gate, and the punch pin may be used as a center pin for forming a central hole in a molded product and also as a gate pressing pin for cutting a gate part off the molded product after injection molding.

### BRIEF DESCRIPTION OF THE DRAWINGS

FIG. 1 is a vertical cross-sectional drawing showing an injection mold assembly according to a first embodiment of the present invention.

FIG. 2 is a horizontal cross-sectional drawing showing a part of the assembly shown in FIG. 1 that has been cut along the line II-II.

FIG. 3(a) is a perspective drawing showing one example of a plate-like product that is formed by the assembly shown in FIG. 1.

FIG. 3(b) is a cross-sectional drawing of this plate-like product.

FIG. 4(a) is a perspective drawing showing one example of a plate-like product that includes a plurality of openings, while FIG. 4(b) is an explanatory drawing showing the mechanism for the production of weld lines when this plate-like product is injection-molded.

FIG. 5(a) and FIG. 5(b) are explanatory drawings that show an injection molding method for a plate-like product with an opening using an injection mold assembly according to a second embodiment of the present invention.

FIG. 6(a) and FIG. 6(b) are explanatory drawings that show an injection molding method for a plate-like product with a depression using an injection mold assembly according to a third embodiment of the present invention.

FIG. 7 shows the overall construction of an injection mold assembly according to a fourth embodiment of the present invention.

FIG. 8 is an explanatory drawing showing a gate cutting operation with the assembly shown in FIG. 7.

FIG. 9 is an explanatory drawing showing a mold opening operation with the assembly shown in FIG. 7.

FIG. 10 is an explanatory drawing showing the eject operation for a molded product with the assembly shown in FIG. 7.

FIG. 11(a) is a perspective drawing showing a molded product produced by the assembly shown in FIG. 7 and FIG. 11(b) is a cross-sectional drawing showing this molded product.

FIG. 12(a) and FIG. 12(b) are explanatory drawings showing examples of injection-molded gear wheels that include shaft holes.

EXPLANATION OF THE REFERENCE NUMERALS

| | |
|---|---|
| 1 | injection mold assembly |
| 2 | fixed-side mold part |
| 3 | moving-side mold part |
| 4 | fixed-side attaching plate |
| 6 | fixed-side mold plate |
| 7 | cavity mold |
| 8 | moving-side attaching plate |
| 10 | moving-side mold plate |
| 11 | core mold |
| 12 | cavity |
| 13 | sprue bushing |
| 14 | ring gate |
| 15 | gate |
| 16 | injection hole |
| 21, 22 | pin through-holes |
| 23, 24 | punch pins |
| 25, 26 | hydraulic cylinders |
| 31, 32 | concave parts |
| 50 | plate-like product with through-holes |
| 51, 52 | through-holes |
| 60 | plate-like product with through-holes |
| 62 | main body |
| 63, 64, 65 | through-holes or openings |
| 66 | gate |
| 70, 70A | injection mold assembly |
| 71, 71A | fixed-side mold plate |
| 72, 72A | moving-side mold plate |
| 73, 73A | cavity |
| 74, 74A | concave parts formed in the fixed-side mold plate |
| 76, 76A | punch pins |
| 100 | injection mold assembly |
| 102 | fixed-side mold part |
| 103 | moving-side mold part |
| 104 | fixed-side attaching plate |
| 108 | fixed-side mold plate |
| 111 | moving-side attaching plate |
| 116 | moving-side mold plate |
| 121, 122 | concave parts |
| 123 | cavity |
| 124 | center pin |
| 125 | eject pin |
| 126 | knock pin |
| 151 | cylindrical guide bushing |
| 152 | circular stepped surface |
| 153 | hollow knock pin |
| 154 | engaging hook |
| 155, 156 | fixed guide pins |

### DETAILED DESCRIPTION OF THE PREFERRED EMBODIMENTS

The following describes, with reference to the attached drawings, several embodiments of an injection mold assembly according to the present invention.

First Embodiment

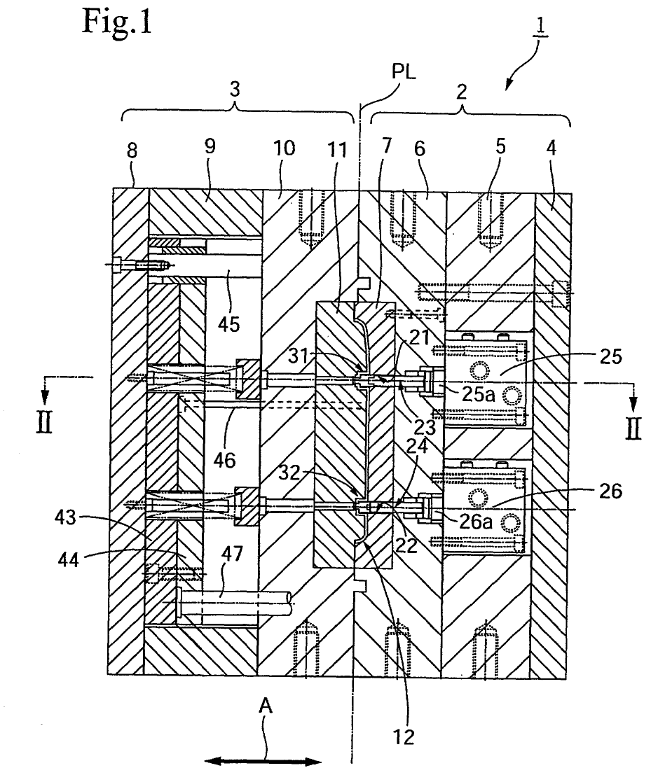

The following describes an injection mold assembly that is a first embodiment of the present invention, with reference to FIG. 1 to FIG. 3.

Plate-like Product with Through-hole

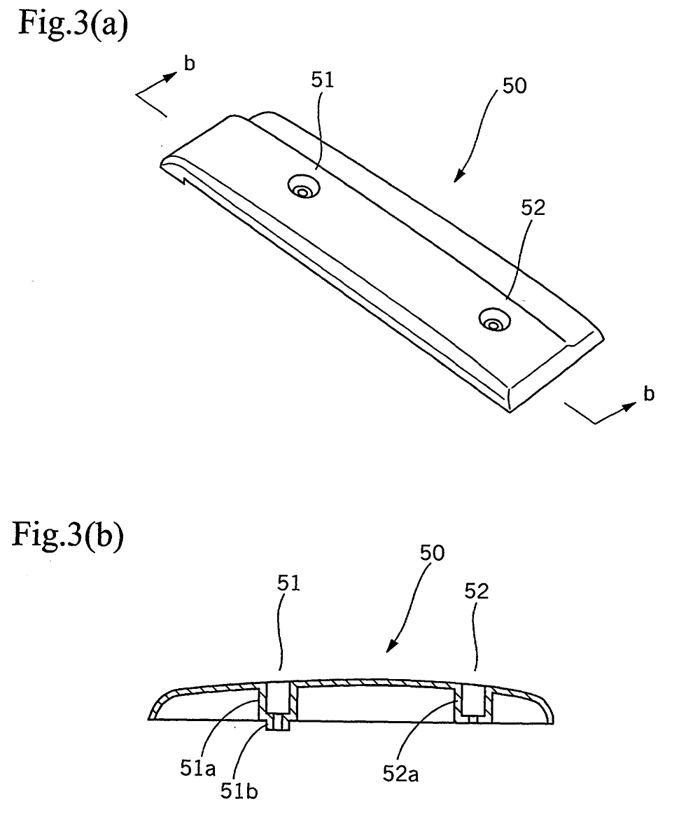

First, the shape of a plate-like product with a through-hole that is formed by an injection mold assembly according to the present invention is described with reference to FIG. 3. As shown in the drawing, a plate-like product 50 for the present example is in the shape of a long, slim rectangle, with the same side having a slightly curved cross-section in both a lengthwise and a widthwise direction. Two through-hole parts 51 and 52 are formed in the plate-like product 50. One of these parts, the through-hole part 51, has a small radius cylindrical part 51b formed concentrically and integrally at an end of a large-radius cylindrical part 51a, while the other part, through-hole part 52, is formed of a cylindrical part 52a.

Injection Mold Assembly

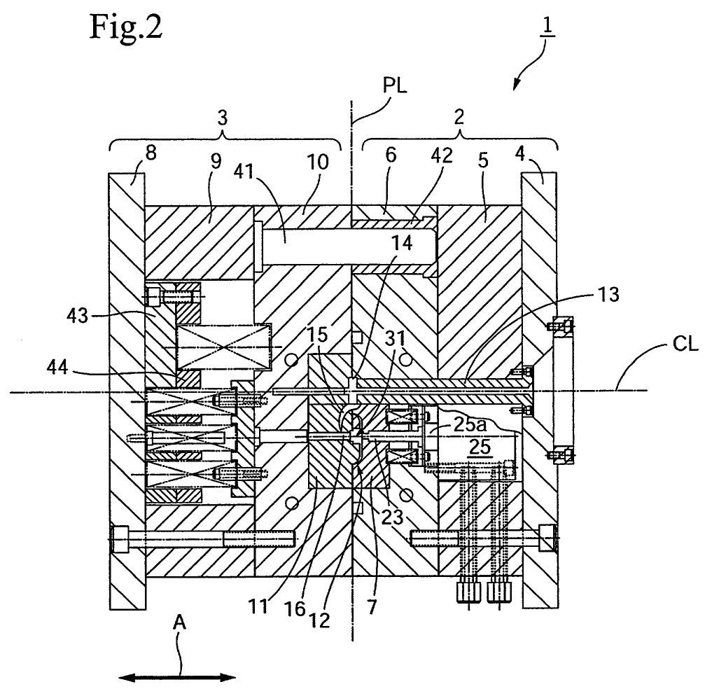

FIG. 1 is a vertical cross-sectional drawing showing the injection mold assembly of the present embodiment, while FIG. 2 is a horizontal cross-sectional drawing showing a part that has been cut along the line VII-VII. When described using these drawings, the injection mold assembly 1 of the present embodiment includes a fixed-side mold part 2 and a moving-side mold part 3 that are separated by the parting line PL. The fixed-side mold part 2 is equipped with a fixed-side attaching plate 4, a runner stripper plate 5 that is attached to the fixed-side attaching plate 4, and a fixed-side mold plate 6 that is attached to the fixed-side attaching plate 4 via the runner stripper plate 5, with a cavity mold 7 being attached to a concave part formed in a surface of the fixed-side mold plate 6.

The moving-side mold part 3 is equipped with a moving-side attaching plate 8 and a moving-side mold plate 10 that is attached to the moving-side attaching plate 8 via a spacer block 9, with a core mold 11 being attached to a concave part formed in a surface of the moving-side mold plate 10. When, as shown in the drawing, the mold assembly is in a closed state with the fixed-side mold part 2 and the moving-side mold part 3 are clamped together, a cavity 12 with a shape that corresponds to the outline form of the plate-like product 50 is formed as a compartment between the cavity mold 7 and the core mold 11.

A sprue bushing 13 is attached to the fixed-side mold part 2 along a mold center line CL, with the end of the sprue bushing 13 being connected to a ring gate 14 that is formed as a compartment between the fixed-side mold plate 6 and the moving-side mold plate 10 when the mold assembly is in the closed state. The ring gate 14 is connected, via a gate 15 that is formed in the core mold 11, to an injection hole 16 that extends in a movement direction A of the fixed-side mold part 2 and is formed inside the core mold 11.

Two through-holes 21 and 22 that extend parallel to the movement direction A are formed in the cavity mold 7 of the fixed-side mold part 2, with punch pins 23 and 24 being inserted into these through-holes 21 and 22 so that the punch pins 23 and 24 are freely movable in an axial direction. The base parts of these punch pins 23 and 24 are coaxially fixed to telescopic rods 25a and 26a of hydraulic cylinders 25 and 26 that form pin moving mechanisms. Each of these hydraulic cylinders 25 and 26 is attached to a rear surface side of the fixed-side mold plate 6. By driving the hydraulic cylinders 25 and 26, the punch pins 23 and 24 can be moved to withdrawal positions (the positions shown by solid lines in the drawing) where the pins 23 and 24 are withdrawn from the cavity and projecting positions (the positions shown by imaginary lines in the drawing) where the pins 23 and 24 project into the cavity.

Circular concave parts 31 and 32 that correspond to the outline forms of the through-holes 51 and 52 of the plate-like product 50 are formed in the core mold 11 of the moving-side mold part 3 at positions that are opposite the punch pins 23 and 24. When the punch pins 23 and 24 project into the cavity at the projecting positions, the front end parts of the punch pins 23 and 24 are inserted into the corresponding circular concave parts 31 and 32, with cavity parts for forming the through-holes 51 and 52 of the plate-like product 50 being formed as compartments between the punch pins 23 and 24 and the circular concave parts 31 and 32. A base part of one of the circular concave parts, circular concave part 31, is connected to the injection hole 16 mentioned above.

It should be noted that a guide pin 41 for guiding the moving-side mold part 3 is attached to the moving-side mold plate 10 of the moving-side mold part 3, with the front end part of the guide pin 41 being inserted into a guide pin bushing 42 attached to the fixed-side mold plate 6 of the fixed-side mold part 2 in a state where the guide pin 41 is freely movable in an axial direction. Furthermore, two eject plates 43 and 44 are attached to the moving-side mold part 3 between the moving-side attaching plate 8 and the fixed-side mold plate 10, with the eject plates 43 and 44 being movable in an axial direction along an eject guide pin 45 that is attached to the moving-side attaching plate. A plurality of eject pins 46 are attached to the eject plates 43 and 44 and are moved by the eject plates 43 and 44 to eject the plate-like product 50 from the core mold when the mold assembly is in an opened state after molding. The eject plates 43 and 44 are restored to their original positions by a return pin 47.

The following is a simplified description of the procedure by which the plate-like product 50 is injection-molded using the injection mold assembly 1 of the present embodiment that has the construction described above.

First, the moving-side mold part 3 that is in the open state is moved towards the fixed-side mold part 2 to produce the closed state. As shown in FIGS. 1 and 2, in the closed state, a cavity 12 that corresponds to the outline form of the plate-like product 50 is formed as a compartment between the molds 2 and 3.

Next, molten resin is injected into the cavity 12, where the molten resin spreads into every corner of the cavity 12. After the molten resin has stopped flowing, the hydraulic cylinders 25 and 26 are driven so that the punch pins 23 and 24 that are at the withdrawal positions shown in FIGS. 1 and 2 are projected as far as the projecting positions shown by the imaginary lines. As a result, the front end parts of the punch pins 23 and 24 are inserted into the concave parts 31 and 32 in the core mold 111, with the through-holes 51 and 52 in the plate-like product 50 being formed by this pressing action.

The state is maintained until the molten resin hardens, after which the punch pins 23 and 24 are withdrawn to the withdrawal positions and the mold is opened. After the mold has been opened, the eject pins 46 eject the plate-like product from the core mold 11. By doing so, a plate-like product 50 with through-holes can be obtained.

In the present embodiment, inside the cavity there are no protrusions at which the flow of the molten resin branches and so could cause weld lines or weld marks to be produced. As a result, the flow of the molten lava does not branch and cause weld lines or weld marks. This means that a plate-like product with through-holes can be precisely manufactured.

Second Embodiment

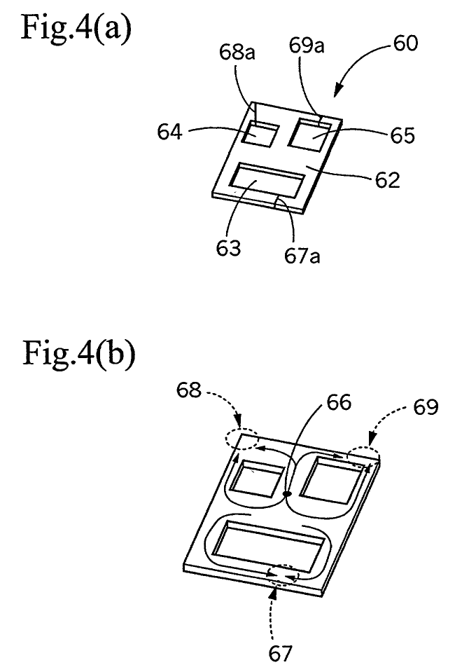

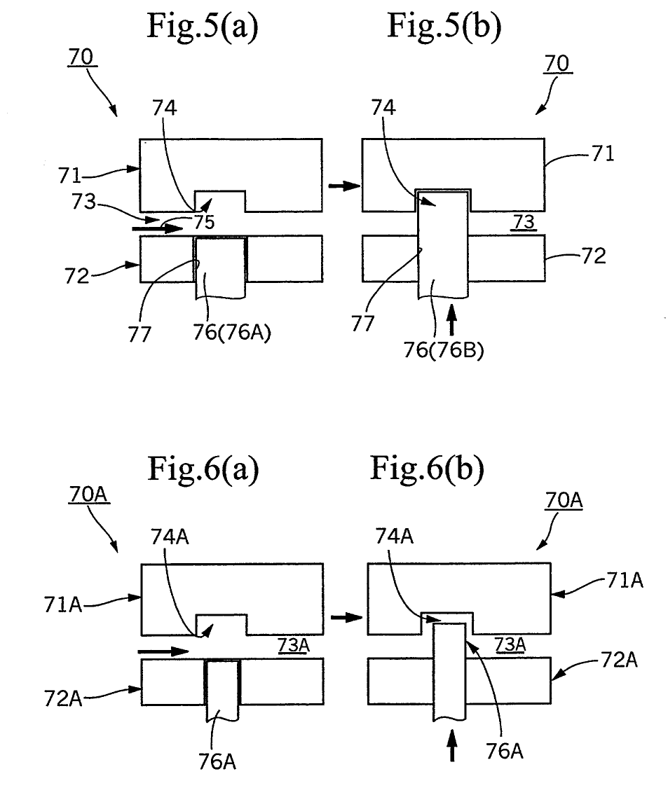

The following describes one example of when a plate-like product 60 with openings like those shown in FIG. 4 is formed. FIGS. 5(a) and 5(b) show the main parts of an injection mold assembly that is suited to forming the plate-like product 60.

With reference to these drawings, an injection mold assembly 70 of the present embodiment has a cavity 73 corresponding to a solid plate-like product, which is the plate-like product 60 without openings 63, 64, and 65, formed between a fixed-side mold plate 71 and a moving-side mold plate 72 as shown in FIG. 5(a). Concave parts 74 for pushing out the openings 63, 64, and 65 are formed in the fixed-side mold plate 71. Through-holes 77 for punch pins 76 that form the openings are formed at positions on the moving-side mold plate 72 that correspond to the concave parts 74, with the punch pins projecting into the cavity 73 in a direction that is perpendicular to a direction 75 in which molten resin flows in the cavity 73 and fitting into the concave parts 74.

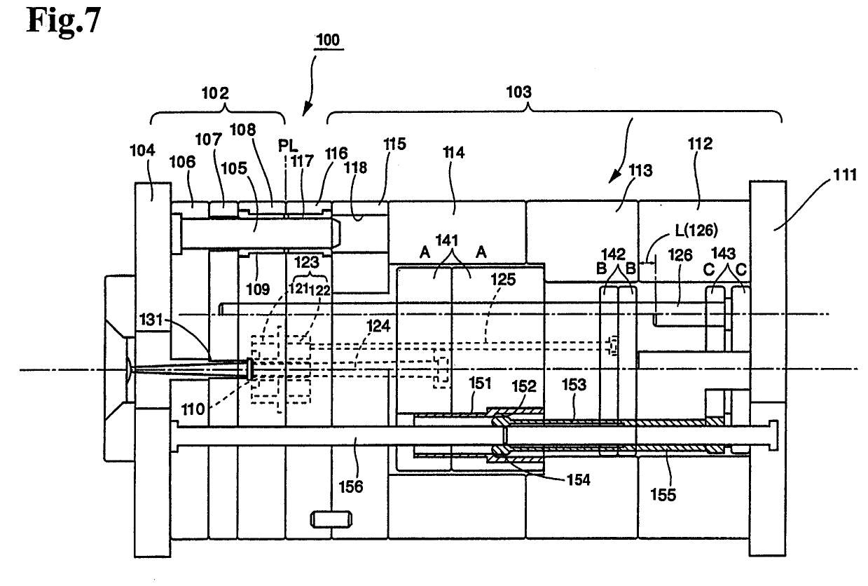

By using the same kind of mechanism as the punch pins 23 and 24 in the injection mold assembly 1 shown in FIGS. 1 and 2, the punch pins 76 are capable of reciprocal linear motion between the withdrawal positions 76A shown in FIG. 5(a) and the projecting positions 76B shown in FIG. 5(b). However, as an alternative it is possible to have the punch pins moved using a pin moving mechanism for moving a center pin, with this being shown in FIGS. 7 to 10 and described later in this specification.

Injection molding is performed as described below. First the mold is closed, producing the state shown in FIG. 5(a). Next, molten resin is injected into the cavity 73 from a gate formed at a position such as that shown in FIG. 4(b). As a result, the molten resin flows in the direction shown by the arrows in FIG. 5(a) and spreads out into the every corner of the cavity 73. At this point, there are no protrusions or the like in the cavity 73 that cause the flow path of the molten resin to split, so that a flow path of molten resin that produces weld lines or weld marks is not created.

The molten resin is allowed to flow into the every corner of the cavity 73 and to stop flowing before the punch pins 76 are made to project into the cavity 73 from the withdrawal positions 76A, so that as shown in FIG. 5(b), the front end surfaces of the punch pins 76 fit into the concave parts 74 formed in the fixed-side mold plate 71.

The molten resin is allowed to harden in this state. After hardening, the punch pins 76 are withdrawn to the withdrawal positions and the resin is removed from the mold, thereby producing a plate-like product 60 in which the openings 63, 64, and 65 are formed. No weld lines or weld marks are present on the surface of this molded product.

Third Embodiment

FIG. 6 shows one example of an injection molding mold that is used when injection molding a plate-like product with depressions. As shown in FIG. 6(a), concave parts 74A for forming an external outline of the depressions of the formed product are formed in a fixed-side mold plate 71A of the injection molding mold 70A. Punch pins 76A for forming the internal outlines of the depressions of the formed product are formed in a moving-side mold plate 72A. The cavity 73A is filled with molten resin and once the resin has stopped flowing, as shown in FIG. 6(b) the punch pins 76A are made to project by a preset distance. The resin is allowed to harden in this state and is then removed from the mold.

In this case also, the mechanism for pressing in the punch pins 76A can be the same kind as the moving mechanism of the punch pins in the injection mold assembly 1 shown in FIGS. 1 and 2. As an alternative it is possible to have the punch pins moved using the same moving mechanism as an injection mold assembly 100 that is shown in FIGS. 7 to 10 and described later in this specification.

It should be noted that when a depression is formed on the opposite side of the formed product, a construction that is the opposite of that shown in FIG. 6 may be used.

Fourth Embodiment

The following describes an example of a different injection mold assembly that is suited to the present invention, with reference to FIG. 7 to FIG. 11.

Molded Gear Wheel with a Shaft Hole

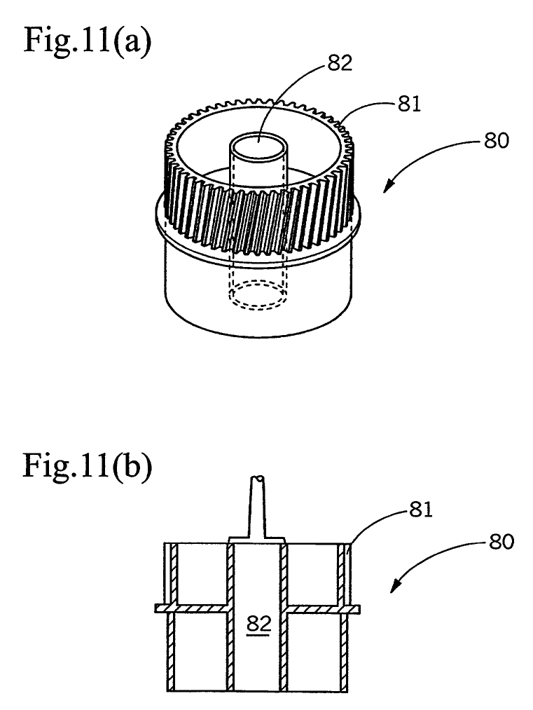

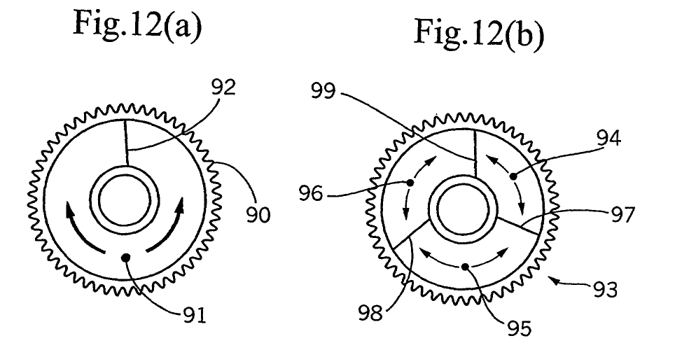

First, the following describes, with reference to FIG. 11, the shape of a molded gear wheel with a shaft hole that is injection-molded by an injection mold assembly according to the present invention. As shown in the drawing, the molded gear wheel 80 has outer teeth 81 formed around its outer circumference and a shaft hole 82 formed in the middle.

Injection Mold Assembly

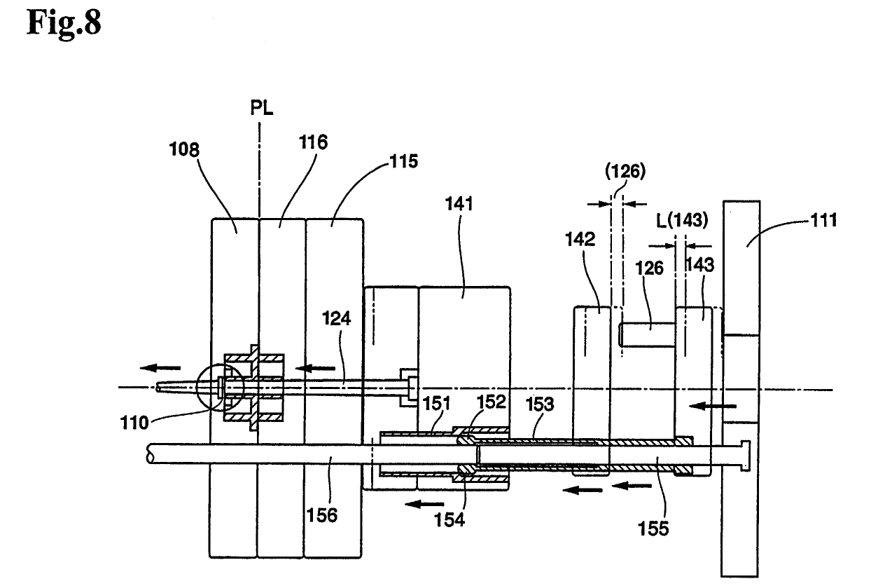

FIG. 7 shows the overall construction of the injection mold assembly of the present embodiment, while FIG. 8 to FIG. 10 are explanatory figures showing the operation of this injection mold assembly. The injection mold assembly 100 of the present embodiment includes a fixed-side mold part 102 and a moving-side mold part 103, with the fixed-side mold part 102 including a fixed-side attaching plate 104, a fixing plate 106 for fixing a guide pin 105 to this fixed-side attaching plate 104, a runner stripper plate 107 that is positioned on top of the fixing plate 106, and a fixed-side mold plate 108 that is positioned on top of the surface of the plate 107. The guide pin 105 passes through the runner stripper plate 107 and through a cylindrical guide bushing 109 that is attached to the fixed-side mold plate 108, with the front end of the guide pin 105 projecting from the fixed-side mold plate 108.

The moving-side mold part 103 includes a moving-side attaching plate 111, a receiving plate 115 that is fixed to the moving-side attaching plate 111 via the a three-stage cylindrical spacer block 112, 113, and 114, and a moving-side mold plate 116 that is attached to the receiving plate 115. The end of the guide pin 105 on the fixed side can be inserted into a cylindrical guide bushing 117 attached to the moving-side mold plate 116, and a pin hole 118 for the guide pin 105 is formed in the receiving plate 115.

Concave parts 121 and 122 for molding purposes are formed in the fixed-side mold plate 108 and the moving-side mold plate 116, so that when the mold assembly is in the closed state shown in FIG. 7, a cavity 123 whose shape corresponds to the injection molded product is formed as a compartment. As shown in FIG. 11, a shaft hole 82 is formed in the center of the injection molded product 80 of the present example, so that when the mold assembly is in the closed state, a center pin 124 for forming the shaft hole 82 passes through the center of the cavity 123 from the moving-side mold plate 116 side, with the shaft hole being formed by this center pin 124. The base of this center pin 124 is attached to a first moving plate 141 that is arranged on a rear surface side of the receiving plate 115, passes through the moving-side mold plate 116 and extends in the movement direction of the moving-side mold plate 116.

A sprue bushing 131 is arranged so as to face the front end of the center pin 124, with the sprue bushing 131 passing through the center of the fixed-side mold part 102 and being open to the surface of the fixed-side attaching plate 104. In the present embodiment, a disc gate 110 is formed at an end surface part of the shaft hole 82 formed in the center of the molded product 80.

On the other hand, a second moving plate 142 is arranged on the rear surface (on the moving-side attaching plate side) of the first moving plate 141, with a base of an eject pin 125 being fixed to the second moving plate 142 and the eject pin 125 extending in the movement direction of the moving-side mold plate 116. When the second moving plate 142 is moved towards the fixed-side mold plate 108, the front end of the eject pin 125 projects into the cavity 123, making it possible to eject the molded product 80 from the cavity 123.

A third moving plate 143 is arranged on the rear surface (on the moving-side attaching plate side) of the second moving plate 142, and a base of a knock pin 126 for moving the second moving plate 142 is fixed to the third moving plate 143, with the knock pin 126 also extending in the movement direction of the moving-side mold plate.

When the injection mold assembly 100 is in a closed state and the third moving plate 143 is moved towards the fixed-side mold plate 108, only the center pin 124 moves and the eject pin 125 does not move, while on the other hand, when the injection mold assembly 100 is in the opened state and the third moving plate 143 is moved towards the fixed-side mold plate 108, the center pin 124 does not move and only the eject pin 125 moves.

The pin moving mechanism that performs this kind of operation has a cylindrical guide bushing 151 that is attached to the first moving plate 141, and a circular stepped surface 152 that is formed on an inner circumferential surface of the cylindrical guide bushing 151 by reducing the diameter on the fixed-side part 102 side. A front end part of a hollow knock pin 153 is coaxially inserted inside this cylindrical guide bushing 151. The base of this hollow knock pin 153 is fixed to the third moving plate 143. An engaging hook 154 that is in the form of a slot and is capable of elastic deformation in a radial direction is formed at the front end of the hollow knock pin 153. As shown in FIG. 7, when the engaging hook 154 is not deformed, the front end external circumference part engages the circular stepped surface 152 of the cylindrical guide bushing 151, but as the engaging hook 154 is squeezed and elastically deforms inwards in the radial direction, the engagement between the external circumference part and the circular stepped surface 152 is released, so that hollow knock pin 153 becomes able to slide along the small-diameter internal circumferential surface of the cylindrical guide bushing 151 towards the fixed-side opening.

A fixed guide pin 155 is coaxially inserted inside the hollow knock pin 153, with the base of the fixed guide pin 155 being fixed to the moving side attaching plate 111. The front end of the fixed guide pin 155 extends as far as the position of the engaging hook 154. On the other hand, a fixed guide pin 156 is coaxially arranged opposite the fixed guide pin 155, with the rear end of this fixed guide pin 156 being fixed to the fixed-side attaching plate 104 side. When the mold assembly is in the closed state, the front end of the fixed guide pin 156 becomes inserted in the engaging hook 154 of the hollow knock pin 153.

With the injection mold assembly 100 of the present embodiment in the closed state shown in FIG. 7, molten resin is introduced into the cavity 123 via the disc gate 110 and then the center pin 124 is pressed in to cut the gate.

If this is described with reference to FIG. 8, when the gate is cut, the third moving plate 143 is pressed towards the fixed-side mold part 102 by a driving mechanism (not shown in the drawing) from the rear surface side of the moving side-attaching plate 111. A distance L (126) is present between the front end of the knock pin 126 attached to the third moving plate 143 and the second moving plate 142, so that the third moving plate 143 can be pressed in by this amount without the second moving plate 142 being pressed. As a result, the eject pin 125 that is attached to the second moving plate 142 is not pressed in.

On the other hand, the first moving plate 141, to which the center pin 124 is attached, moves due to being simultaneously pressed when the third moving plate 143 is pressed. In other words, the fixed guide pin 156 passes through the engaging hook 154 formed in the front end of the hollow knock pin 153 that is attached to the third moving plate 143, so that the engaging hook 154 is not squeezed inwards in the radial direction. Consequently, the engaging hook 154 maintains a state where the engaging hook 154 engages the circular stepped surface 152 of the cylindrical guide bushing 151 attached to the first moving plate 141. This means that when the third moving plate 143 is pressed, the first moving plate 141 is pressed by the engaging hook 154 of the hollow knock pin 153 attached to the third moving plate 143. The center pin 124 is attached to the first moving plate 141 and when the center pin 124 is pressed in, the front end of the center pin 124 presses the sprue bushing 131. As a result, the part of the disc gate 110 that is formed at this part is pressed off the molded product and separated. When the gate is cut in this way, the moved distance L (143) of the third moving plate 143 is shorter than the distance L (126), so that the second moving plate 142 to which the eject pin 125 is attached is not pressed during the gate cutting operation.

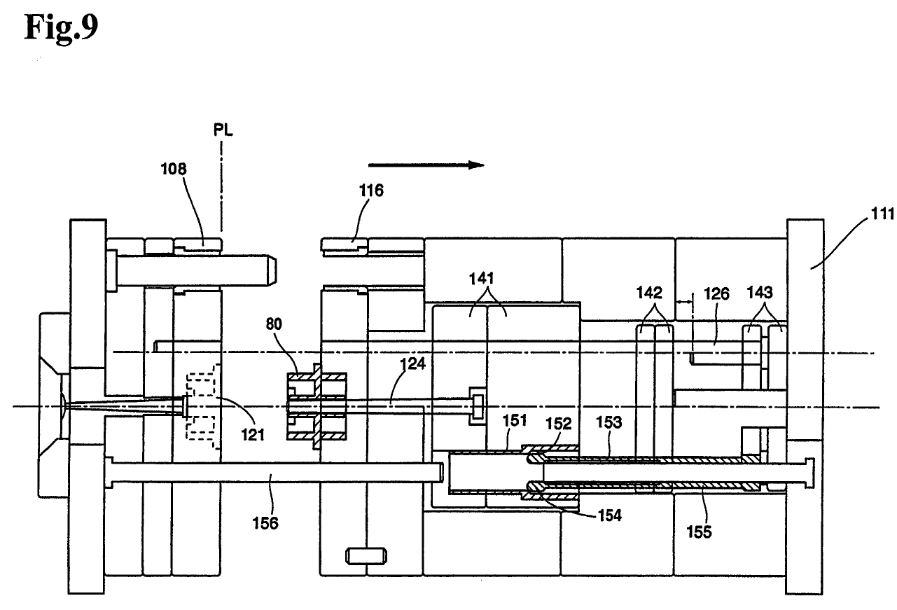

As shown in FIG. 9, after the gate has been cut, the third moving plate 143 is restored to its original position, and the moving-side mold 103 is withdrawn from the fixed-side mold part 102 to open the mold. When the mold assembly is opened, the fixed guide pin 156 on the moving side is completely withdrawn from the engaging hook 154 that is formed in the front end of the hollow knock pin 153.

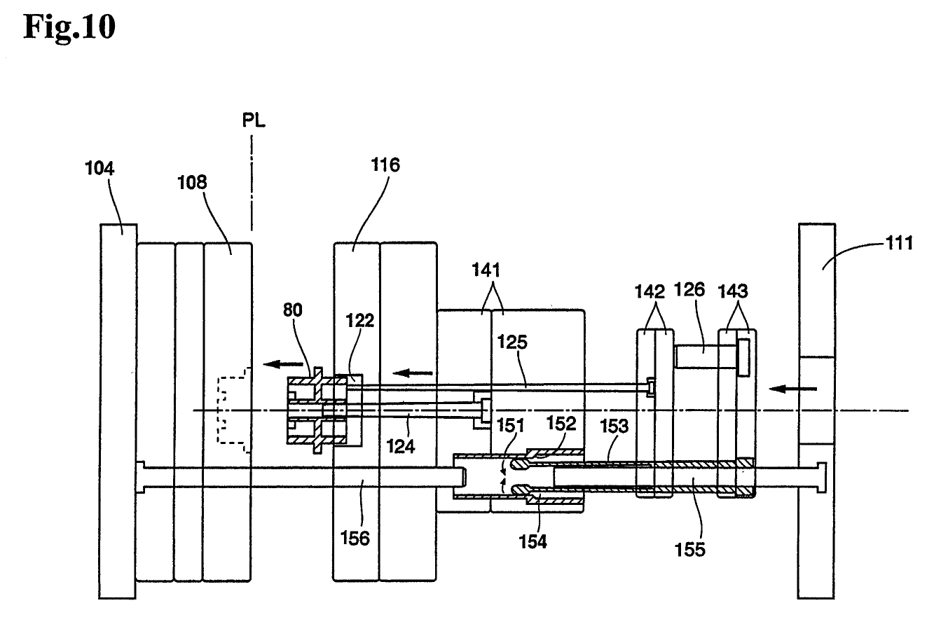

Next, with the mold assembly in the opened state, the third moving plate 143 is pressed in by an amount that exceeds the distance L (126). As a result, as shown in FIG. 10, the second moving plate 142 is pressed in by the knock pin 126, so that the eject pin 125 that is attached to the second moving plate 142 is also pressed in and molded product 80 is ejected from the concave part 122 of the moving-side mold plate 116 by the front end of the ejector pin 125.

At this point, the first moving plate 141 does not move, so that the center pin 124 is not pressed in. In other words, when the hollow knock pin 153 is pressed in, the engaging hook 154 formed in the front end of the hollow knock pin 153 is pressed against the circular stepped surface 152 of the guide bushing 151 of the first moving plate 141. Since the fixed guide pin 156 that stops the engaging hook 154 from becoming squeezed and elastically deforming inwards in a radial direction is not present on the inside of the engaging hook 154, when pressed in the engaging hook 154 is squeezed and elastically deforms, so as to enter the small-diameter internal circumferential surface of the guide sleeve 151 and be pressed in along this internal circumferential surface. As a result, the engagement of the hollow knock pin 153 and the first moving plate 141 is released, so that the first moving plate 141 is not pressed in.

As described above, in the injection mold assembly 100 of the present embodiment, a molded product such as a gear wheel or a pulley that is formed with a central shaft hole is formed by introducing molten resin in a cavity from a disc gate that is formed at an end part of the shaft hole. Consequently, the molding of a injection-molded product such as a gear wheel or a pulley that is provided with a central shaft hole can be performed without producing weld lines or weld marks.

After injection molding has been performed, the cutting of the gate by pressing in the center pin and the ejecting of the molded product by pressing in the eject pin after opening the mold are achieved by pressing in the third moving plate. Accordingly, the cutting of the gate and the ejection of the molded product can be realized by a simple operation.

As described above, in the present invention molten resin is injected into a mold cavity in which there are no protruding parts that cause the flow path of the molten resin to branch. After the molten resin injected into the cavity has spread out into every corner and stopped flowing, punch pins for forming depressions, through-holes, etc., are pressed into the molten resin that fills the cavity so as to form depressions, through-holes, etc., and the molten resin is then allowed to harden in this state.

Accordingly, according to the present invention, plate-like molded products that have depressions, through-holes, etc., can be injection-molded without weld lines or weld marks being produced in the surfaces of the molded products. This means that plate-like molded products that have depressions, through-holes, etc., can be accurately produced.

What is claimed is:

1. An injection molding method for injection molding a plate-like product that is provided with a through-hole, a depression, and the like, comprising steps of:
forming a cavity, which corresponds to a shape of the product without the through-hole or the depression, as a compartment between a fixed-side mold plate and a moving-side mold plate;
injecting molten resin into the cavity;
forming a part corresponding to the through-hole or the depression by having a punch pin project into the cavity from one of a fixed-side mold plate side and a moving-side mold plate side after the molten resin has spread out into every corner of the cavity and has stopped flowing; and
withdrawing the punch pin from the cavity after the molten resin that fills the cavity has hardened.

2. An injection mold assembly that is used for forming a plate-like product including a through-hole or the like according to the injection-molding method of claim 1, comprising:
a fixed-side mold part;
a moving-side mold part;
a cavity that is formed as a compartment between the fixed-side mold part and the moving-side mold part when the injection mold assembly is in a closed state;
a punch pin that can be moved to a projecting position where the punch pin projects into the cavity and a withdrawal position where the punch pin is withdrawn from the cavity; and
a pin moving mechanism for moving the punch pin to the projecting position and the withdrawal position.

3. An injection mold assembly according to claim 2, wherein the pin moving mechanism includes a fluid pressure cylinder.

4. An injection mold assembly according to claim 3, wherein the pin moving mechanism is attached to the fixed-side mold part side.

5. An injection mold assembly according to claim 1, further comprising an eject pin for ejecting a molded product from the moving-side mold plate when the injection mold assembly is in an opened state, wherein the pin moving mechanism has only the punch pin project into the cavity when the injection mold assembly is in the closed state and has only the eject pin project into the cavity when the injection mold assembly is in the opened state.

6. An injection mold assembly according to claim 5, wherein the pin moving mechanism includes:
a first moving plate to which the punch pin is attached;
a second moving plate to which the eject pin is attached;
a third moving plate to which a hollow knock pin for moving the first moving plate and a knock pin for moving the second moving plate are attached; and
a cylindrical guide bushing that is attached to the first moving plate and guides a front end part of the hollow knock pin,
wherein the hollow knock pin has an engaging hook part at a front end part of the hollow knock pin, the engaging hook part being capable of switching between a state where the engaging hook part is elastically displaced in a radial direction relative to the guide bushing and engages the guide bushing and a state where the engaging hook part is released from the guide bushing,
a fixed-side attaching plate to which the fixed-side mold plate is attached is equipped with a fixed-side guide pin, and
when the injection mold assembly is in the closed state, the fixed-side guide pin is in a state where a front end part of the fixed-side guide pin has been inserted in the hollow knock pin so that the engaging hook part of the hollow knock pin does not elastically deform, while when the injection mold assembly is in the opened state, the fixed-side guide pin is in a state where the front end part of the fixed-side guide pin has been withdrawn from the hollow knock pin.

7. An injection mold assembly, comprising:
a fixed-side mold plate;
a moving-side mold plate;
a punch pin that is capable of projecting into a cavity formed between the fixed-side mold plate and the moving-side mold plate when the injection mold assembly is in a closed state;
an eject pin for ejecting a molded product from the moving-side mold plate when the injection mold assembly is in an opened state; and
a pin moving mechanism for having only the punch pin project into the cavity when the injection mold assembly is in the closed state and having only the eject pin project into the cavity when the injection mold assembly is in the opened state.

8. An injection mold assembly according to claim 7, wherein the pin moving mechanism includes:
a first moving plate to which the punch pin is attached;
a second moving plate to which the eject pin is attached;
a third moving plate to which a hollow knock pin for moving the first moving plate and a knock pin for moving the second moving plate are attached; and
a cylindrical guide bushing that is attached to the first moving plate and guides an front end part of the hollow knock pin,
wherein the hollow knock pin has an engaging hook part at a front end part of the hollow knock pin, the engaging hook part being capable of switching between a state where the engaging hook part is elastically displaced in a radial direction relative to the guide bushing and engages the guide bushing and a state where the engaging hook part is released from the guide bushing,
a fixed-side attaching plate to which the fixed-side mold plate is attached is equipped with a fixed-side guide pin, and
when the injection mold assembly is in the closed state, the fixed-side guide pin is in a state where a front end part of the fixed-side guide pin has been inserted in the hollow knock pin so that the engaging hook part of the hollow knock pin does not elastically deform, while when the injection mold assembly is in the opened state, the fixed-side guide pin is in a state where the front end part of the fixed-side guide pin has been withdrawn from the hollow knock pin.

9. An injection mold assembly according to any of claims 7 and 8,
wherein a gate of the cavity is a disc gate, and the punch pin functions as a center pin for forming a central hole in a molded product and also as a gate pressing pin for cutting a gate part off the molded product after injection molding.
